(19) United States
(12) Patent Application Publication
(10) Pub. No.: US 2025/0304495 A1
(43) Pub. Date: Oct. 2, 2025

(54) BASALT FIBER REINFORCED CONCRETE USING EXCAVATED MATERIAL AS AGGREGATE AND METHOD FOR MANUFACTURING SAME

(71) Applicants: XI'AN THERMAL POWER RESEARCH INSTITUTE CO., LTD., Xi'an (CN); TIANJIN HUANENG YANGLIUQING CO-GENERATION LIMITED LIABILITY COMPANY, Tianjin (CN); TSINGHUA UNIVERSITY, Beijing (CN)

(72) Inventors: Yezhu SUN, Xi'an (CN); Peng LIN, Xi'an (CN); Bin HUANG, Xi'an (CN); Changqian LIANG, Xi'an (CN); Dan LI, Xi'an (CN); Lin ZHANG, Xi'an (CN); Zhiyun DENG, Xi'an (CN); Xiang MA, Xi'an (CN); Hao ZHOU, Xi'an (CN); Fan FANG, Xi'an (CN); Libing DU, Xi'an (CN); Xiao LIU, Xi'an (CN)

(73) Assignees: XI'AN THERMAL POWER RESEARCH INSTITUTE CO., LTD., Xi'an (CN); TIANJIN HUANENG YANGLIUQING CO-GENERATION LIMITED LIABILITY COMPANY, Tianjin (CN); TSINGHUA UNIVERSITY, Beijing (CN)

(21) Appl. No.: 19/023,034

(22) Filed: Jan. 15, 2025

(30) Foreign Application Priority Data
Mar. 29, 2024 (CN) 202410379865.7

(51) Int. Cl. C04B 14/46; B28B 1/087; C04B 14/04; C04B 20/02; C04B 24/26; C04B 28/04; C04B 40/00; C04B 103/30

(52) U.S. Cl. CPC C04B 14/4668; C04B 14/048; C04B 20/026; C04B 24/2647; C04B 28/04; C04B 40/0046; C04B 40/0067; B28B 1/0873; C04B 2103/302

(57) ABSTRACT

The disclosure provides a basalt fiber reinforced concrete using an excavated material as aggregate, and a method for manufacturing same. The basalt fiber reinforced concrete is manufactured from ingredients according to a mix proportion as follows: 100 parts of cement, 300 parts of coarse aggregate, 226.4 parts of fine aggregate, 40 parts of water, 1 part of a water reducing agent, and chopped basalt fibers, where gneiss is crushed to manufacture the coarse aggregate and the fine aggregate, and is sieved to obtain first coarse aggregate with a grain size of 5 mm to 10 mm, second coarse aggregate with a grain size of 10 mm to 20 mm, and the fine aggregate with a grain size of 0.37 mm to 0.52 mm; in the coarse aggregate, an ingredient mix proportion of the first coarse aggregate to the second coarse aggregate is 1:1; and a volume fraction of the chopped basalt fibers is 0% to 0.5%, and an optimal volume fraction is 0.2%. Through the disclosure, an optimal fiber proportion suitable for lining structures on engineering sites can be determined.

### TECHNICAL FIELD

The disclosure relates to the technical field of building materials, in particular to a basalt fiber reinforced concrete using an excavated material as aggregate, and a method for manufacturing same.

### BACKGROUND

Since the 1970s, adding randomly distributed fibers to concrete to create fiber reinforced concrete has been identified and practiced as a solution for improving the tensile strength, the bending strength and the splitting tensile strength of concrete. Fibers varying in geometric size and physical and mechanical property can fully exert their respective strengthening effects in different layers and stress stages of concrete, so as to significantly improve the toughness and the impact resistance of the concrete.

In order to apply fiber reinforced concrete to practical construction projects, it is necessary to understand the basic mechanical properties of the fiber reinforced concrete to determine fiber proportions suitable for practical projects. Besides, previous researches are mainly focused on the tensile and compressive constitutive relation of steel fiber reinforced concrete, but few researches are concerned with the stress-strain relations of basalt fiber reinforced concrete under uniaxial tensile and compression conditions, and no constitutive relation is applicable to the basalt (BFRC). Since numerical simulation has become a powerful tool in concrete structural analysis to predict a structural response under different loads and external factors, and obtaining the constitutive relation of the basalt is an effective means to accurately perform numerical simulation analysis, it is necessary to study the tensile and compressive constitutive relation of the basalt.

### SUMMARY OF THE INVENTION

The disclosure aims to solve one technical problem in the prior art at least to some extent.

In view of this, a first objective of the disclosure is to provide a basalt fiber reinforced concrete using an excavated material as aggregate, so as to determine an optimal fiber proportion suitable for lining structures on engineering sites.

A second objective of the disclosure is to provide a method for manufacturing basalt fiber reinforced concrete using excavated material as aggregate.

In order to achieve the above objectives, a first aspect of examples of the disclosure provides a basalt fiber reinforced concrete using an excavated material as aggregate. The basalt fiber reinforced concrete is manufactured from ingredients according to a mix proportion as follows: 100 parts of cement, 300 parts of coarse aggregate, 226.4 parts of fine aggregate, 40 parts of water, 1 part of a water reducing agent, and chopped basalt fibers, where gneiss is crushed to manufacture the coarse aggregate and the fine aggregate, and is sieved to obtain first coarse aggregate with a grain size of 5 mm to 10 mm, second coarse aggregate with a grain size of 10 mm to 20 mm, and the fine aggregate with a grain size of 0.37 mm to 0.52 mm; in the coarse aggregate, an ingredient mix proportion of the first coarse aggregate to the second coarse aggregate is 1:1; and a volume fraction of the chopped basalt fibers is 0% to 0.5%, and an optimal volume fraction is 0.2%.

The gneiss used to manufacture the coarse aggregate and the fine aggregate has natural density of 2.72 g/cm³ to 2.75 g/cm³, dry density of 2.71 g/cm³ to 2.74 g/cm³, a saturated water absorption rate of 0.21 to 0.34, saturated compressive strength of 54 MPa to 86 MPa, a softening coefficient of 0.6 to 0.78, and a freeze-thaw loss rate of 0.01 to 0.05; after the gneiss is crushed and sieved, the obtained coarse aggregate has apparent density of 2.69 g/cm³ to 2.72 g/cm³, a water absorption rate of 0.82% to 0.89%, dry bulk density of 1.86 g/cm³ to 1.88 g/cm³, close bulk density of 2.10 g/cm³ to 2.11 g/cm³, and a particle size modulus of 7.54 to 8.14; and the fine aggregate has bulk density of 1.57 g/cm³ to 1.61 g/cm³, apparent density of 2.75 g/cm³ to 2.76 g/cm³, and a fineness modulus of 2.35 to 3.45.

The water reducing agent is a polycarboxylate high-performance water reducing agent, and has density of 1029 kg/m³ and a water reducing rate of 28%, and a mixing amount of the water reducing agent is 1% of cement mass.

The cement is ordinary Portland cement with a strength grade of P.O32.5. P.O is the code of ordinary Portland cement, 32.5 is the strength grade, and 32.5 indicates the 28-day compressive strength of cement ≥32.5 MPa, referring to the national standard GB175-2007.

The chopped basalt fibers have a length of 12 mm, and are manufactured from chemical ingredients according to an ingredient proportion as follows:

45% to 60% of SiO₂; 12% to 19% of Al₂O₃; 4% to 6% of CaO; 3% to 4% of MgO; 2.5% to 4% of Na₂O+K₂O; 0.9% to 2% of TiO₂; and 7% to 15% of FeO+Fe₂O₃.

The chopped basalt fibers have material parameters as follows:
a diameter is 0.013 mm, tensile strength is 3300 MPa to 4500 MPa, an elastic modulus is 95 GPa to 115 GPa, a capacity is 2650 kg/m³, a fracture elongation is 3.2%, a shape is flat and straight shape, a service temperature is −269° C. to 700° C., a thermal conductivity coefficient is 0.031 w/m·k to 0.038 w/m·k, a specific volume resistance is 1×10¹² ohm·M, and a sound absorption coefficient is 0.9 to 0.99.

In order to achieve the above objectives, a second aspect of the examples of the disclosure provides a method for manufacturing basalt fiber reinforced concrete using an excavated material as aggregate. The manufacturing includes:
placing 150 parts of coarse aggregate and fine aggregate into a mixer with a mixing drum having a wet inner surface, adding chopped basalt fibers with a preset volume fraction in a continuous mixing process, and continuously mixing for two first preset time intervals after addition is completed;
turning off the mixer, slowly placing 100 parts of cement into the mixing drum, and starting the mixer to mix for one first preset time interval;
slowly and evenly placing 40 parts of water and 1 part of a water reducing agent into the mixing drum, continuing to mix for two first preset time intervals, and then taking out a mixture;
placing the mixture into a mold, and vibrating the mold on a vibration table for 1 to 2 first preset time intervals, so as to guarantee that a test piece is vibrated compactly; and
performing demolding after sealing and curing with a plastic film for a second preset time interval, and placing the test piece into a standard curing room for curing.

In a case that the chopped basalt fibers are agglomerated when mixed after added, the mixer is halted, and agglomerated fibers are scattered and then mixing is continued.

A curing temperature in the standard curing room is 20±2° C., and relative humidity is 95%.

The first preset time interval is one minute, and the second preset time interval is one day.

Different from the prior art, the disclosure provides a basalt fiber reinforced concrete using an excavated material as aggregate, and a method for manufacturing same. The basalt fiber reinforced concrete is manufactured from ingredients according to a mix proportion as follows: 100 parts of cement, 300 parts of coarse aggregate, 226.4 parts of fine aggregate, 40 parts of water, 1 part of a water reducing agent, and chopped basalt fibers, where gneiss is crushed to manufacture the coarse aggregate and the fine aggregate, and is sieved to obtain first coarse aggregate with a grain size of 5 mm to 10 mm, second coarse aggregate with a grain size of 10 mm to 20 mm, and the fine aggregate with a grain size of 0.37 mm to 0.52 mm; in the coarse aggregate, an ingredient mix proportion of the first coarse aggregate to the second coarse aggregate is 1:1; and a volume fraction of the chopped basalt fibers is 0% to 0.5%, and an optimal volume fraction is 0.2%. Through the disclosure, an optimal fiber proportion suitable for lining structures on engineering sites can be determined.

Additional aspects and advantages of the disclosure will partially be set forth in the following description, will partially become apparent from the following description, or will be learned by practice of the disclosure.

### BRIEF DESCRIPTION OF THE DRAWINGS

FIG. 1 is a schematic diagram of axial compressive strength of cubic test pieces manufactured by adding different volume fractions of chopped basalt fibers to basalt fiber reinforced concrete using an excavated material as aggregate according to the disclosure in a uniaxial compression test;

FIG. 2 is a schematic diagram showing calculation of compressive work of cubic test pieces manufactured by adding different volume fractions of chopped basalt fibers to basalt fiber reinforced concrete using an excavated material as aggregate according to the disclosure under a uniaxial compression load;

FIG. 3 is a schematic diagram of compressive strength of cubic test pieces manufactured by adding different volume fractions of chopped basalt fibers to basalt fiber reinforced concrete using an excavated material as aggregate according to the disclosure in a uniaxial compression test;

FIG. 4 is a schematic diagram of peak tensile strength results of cubic test pieces manufactured by adding different volume fractions of chopped basalt fibers to basalt fiber reinforced concrete using an excavated material as aggregate according to the disclosure in a uniaxial tensile test;

FIG. 5 is a schematic diagram of splitting tensile test results of cubic test pieces manufactured by adding different volume fractions of chopped basalt fibers to basalt fiber reinforced concrete using an excavated material as aggregate according to the disclosure;

FIG. 6 is a schematic diagram of bending strength of cubic test pieces manufactured by adding different volume fractions of chopped basalt fibers to basalt fiber reinforced concrete using an excavated material as aggregate according to the disclosure in a four-point bending test; and

FIG. 7 is a uniaxial tensile stress-strain curve fitting diagram of plain concrete and basalt fiber reinforced concrete with an optimal proportion in basalt fiber reinforced concrete using an excavated material as aggregate according to the disclosure.

### DETAILED DESCRIPTION

Examples of the disclosure are described in detail below and illustratively shown in the accompanying drawings. The same or similar reference numerals denote the same or similar elements or elements having the same or similar functions throughout. The examples described below by reference to the drawings are illustrative for explaining the disclosure and are not to be construed as limiting the disclosure.

A first example of the disclosure provides a basalt fiber reinforced concrete using an excavated material as aggregate. The basalt fiber reinforced concrete is manufactured from ingredients according to a mix proportion as follows: 100 parts of cement, 300 parts of coarse aggregate, 226.4 parts of fine aggregate, 40 parts of water, 1 part of a water reducing agent, and chopped basalt fibers, where gneiss is crushed to manufacture the coarse aggregate and the fine aggregate, and is sieved to obtain first coarse aggregate with a grain size of 5 mm to 10 mm, second coarse aggregate with a grain size of 10 mm to 20 mm, and the fine aggregate with a grain size of 0.37 mm to 0.52 mm; in the coarse aggregate, an ingredient mix proportion of the first coarse aggregate to the second coarse aggregate is 1:1; and a volume fraction of the chopped basalt fibers is 0% to 0.5%, and an optimal volume fraction is 0.2%.

The gneiss used to manufacture the coarse aggregate and the fine aggregate has natural density of 2.72 g/cm³ to 2.75 g/cm³, dry density of 2.71 g/cm³ to 2.74 g/cm³, a saturated water absorption rate of 0.21 to 0.34, saturated compressive strength of 54 MPa to 86 MPa, a softening coefficient of 0.6 to 0.78, and a freeze-thaw loss rate of 0.01 to 0.05. After the gneiss is crushed and sieved, the obtained coarse aggregate has apparent density of 2.69 g/cm³ to 2.72 g/cm³ with an average of 2.71 g/cm³, a water absorption rate of 0.82% to 0.89% with an average of 0.84%, dry bulk density of 1.86 g/cm³ to 1.88 g/cm³ with an average of 1.87 g/cm³, close bulk density of 2.10 g/cm³ to 2.11 g/cm³ with an average of 2.10 g/cm³, and a particle size modulus of 7.54 to 8.14 with an average of 7.86. The fine aggregate has bulk density of 1.57 g/cm³ to 1.61 g/cm³ with an average of 1.59 g/cm³, apparent density of 2.75 g/cm³ to 2.76 g/cm³ with an average of 2.75 g/cm³, and a fineness modulus of 2.35 to 3.45 with an average of 2.89.

The water reducing agent is a polycarboxylate high-performance water reducing agent, and has density of 1029 kg/m³ and a water reducing rate of 28%, and a mixing amount of the water reducing agent is 1% of cement mass. Ordinary Portland cement with a strength grade of P.O32.5 is used for a test.

The chopped basalt fibers have a length of 12 mm, and are manufactured from chemical ingredients according to an ingredient proportion as follows:

45% to 60% of SiO₂; 12% to 19% of Al₂O₃; 4% to 6% of CaO; 3% to 4% of MgO; 2.5% to 4% of Na₂O+K₂O; 0.9% to 2% of TiO₂; and 7% to 15% of FeO+Fe₂O₃.

The chopped basalt fibers have material parameters as follows:
a diameter is 0.013 mm, tensile strength is 3300 MPa to 4500 MPa, an elastic modulus is 95 GPa to 115 GPa, a capacity is 2650 kg/m³, a fracture elongation is 3.2%, a shape is flat and straight shape, a service temperature is −269° C. to 700° C., a thermal conductivity coefficient is 0.031 w/m·k to 0.038 w/m·k, a specific volume resistance is 1×10¹² ohm·M, and a sound absorption coefficient is 0.9 to 0.99.

A second example of the disclosure provides a method for manufacturing basalt fiber reinforced concrete using an excavated material as aggregate. The manufacturing includes:
150 parts of coarse aggregate and fine aggregate are placed into a mixer with a mixing drum having a wet inner surface, chopped basalt fibers with a preset volume fraction are added in a continuous mixing process, and continuously mixing is performed for two first preset time intervals after addition is completed;
the mixer is turned off, 100 parts of cement are slowly placed into the mixing drum, and the mixer is started to mix for one first preset time interval;
40 parts of water and 1 part of a water reducing agent are placed into the mixing drum slowly and evenly, mixing continues for two first preset time intervals, and then a mixture is taken out;
the mixture is placed into a mold, and the mold is vibrated on a vibration table for 1 to 2 first preset time intervals, so as to guarantee that a test piece is vibrated compactly; and
demolding is performed after sealing and curing with a plastic film for a second preset time interval, and the test piece is placed into a standard curing room for curing.

In a case that the chopped basalt fibers are agglomerated when mixed after added, the mixer is halted, and agglomerated fibers are scattered and then continue being mixed.

A curing temperature in the standard curing room is 20±2° C., and relative humidity is 95%.

The first preset time interval is one minute, and the second preset time interval is one day.

After the concrete in the foregoing example is obtained through the above manufacturing method, in the following example of the disclosure, compressive strength, tensile strength, bending strength, toughness and other test results of concrete test pieces with different volume fractions of basalt fibers (volume fraction of 0%, 0.1%, 0.2%, 0.3%, 0.4%, and 0.5%) are compared, such that an optimal fiber proportion suitable for lining structures on engineering sites is determined. In conjunction with a concrete uniaxial compression (tension) stress-strain relation equation given in the Code for Design of Concrete Structures (GB 50010-2010), fitting is performed on uniaxial compression (tension) test results of concrete, and fitting parameters of axial compression (tension) curves applicable to the fiber reinforced concrete (FRC) in the disclosure are proposed. Compression, tension and bending property mechanisms of the fiber concrete are analyzed, and a mechanism of improving mechanical property mechanisms of the concrete by fibers is analyzed.

Specifically, the manufacturing method involved in the second example of the disclosure is designed based on the concrete with a strength grade of C30 according to design requirements and field application conditions of a lining of a deep buried tunnel with reference to relevant proportion calculation provisions in the Specification for Mix Proportion Design of Ordinary Concrete. Finally, a mix proportion of a concrete matrix is obtained through trial mixing as shown in Table 1

TABLE 1
Design of mix proportion of C30 concrete

| | | | | | | Water |
|---|---|---|---|---|---|---|
| | | Coarse aggregate | | Fine | | reducing |
| Raw material | Cement | (10-20 mm) | (5-10 mm) | aggregate | Water | agent |
| Content/(kg · m⁻³) | 375 | 562.5 | 562.5 | 849 | 150 | 3.75 |

Dispersibility of fibers is important for improving performance of fiber reinforced concrete. In order to make fibers in the concrete have desirable dispersibility, with reference to relevant specifications and literature, a mixing process used in a test is as follows:
1) weighed coarse aggregate and fine aggregate are poured into a mixer with a wet surface and mixed for one minute. During mixing, basalt fibers are evenly added, and continue being mixed for about two minutes after the fibers being added. Then, in a case that the fibers are agglomerated when mixed, the mixer needs to be halted, and the agglomerated fibers need to be scattered, and then continue being mixed.
2) cement is poured into the mixing drum slowly, and the mixer is started for about one minute.
3) water and a water reducing agent are poured into the mixer slowly and evenly, and after mixing for about 2 minutes, a mixture is poured out. The mixture is placed into a mold, and vibrated on a vibration table for 1 to 2 minutes, so as to guarantee that a test piece is vibrated compactly.
4) demolding is performed after sealing and curing with a plastic film for one day, and the test piece is placed into a standard curing room for curing.

Each group of test pieces are cured in a standard curing room for 28 days and then tested.

Test methods include an axial compression test, an axial tension test, a split tension test and a four-point bending test on prisms and cubes. Three samples are designed for each test. Six groups of chopped basalt fibers are provided in proportion, and proportions are 0% to 0.5% respectively. A size of each test piece is set with reference to CECS2009 to the greatest extent. An axial tension test piece is 300 mm×100 mm×100 mm in length, width and height, and a split tension test piece is a cube with 100 mm in side length. An axial compression test prism is 300 mm×150 mm×150 mm in length, width and height, and an axial compression test cube is a cube with 150 mm in side length. A four-point bending test piece is 300 mm×100 mm×100 mm in length, width and height.

### (1) Uniaxial Tensile Test

The uniaxial tensile test is performed by reserving steel bars in a prismal test piece. The test is performed on an MTS810 hydraulic servo material testing machine. The testing machine has a load capacity of 100 kN, a displacement stroke of 150 mm, and a maximum tensile rate of 250 mm/s, applies a monotonic load or cyclic load to a material or a structural member, and performs monotonic tensile, compression, bending, fatigue and fracture toughness tests. Axial deformation of a single test piece is calculated by averaging measurement results of two extensometers. During the test, loading is performed at a loading rate of 0.1 mm/min until the test piece is destroyed.

A splitting tension test is performed by a rigid INSTRON 8506 four-column hydraulic servo testing system of department of water conservancy of Tsinghua University. The system has maximum vertical static load pressure of ±3000 kN, maximum dynamic load pressure of ±2500 kN and a maximum frequency of 6 Hz. Displacement, strain and load control may be implemented by the system. During the test, a displacement control method is used to load the test piece at a loading rate of 0.08 mm/min until the test piece is destroyed. A maximum splitting load is recorded.

### (2) Uniaxial Compression Test

With reference to specification, a prismal test curve is selected as a uniaxial compressive stress-strain curve. In order to obtain an accurate compressive stress-strain curve of the FRC and prevent sudden failure of a test piece caused by insufficient rigidity of the testing machine, the rigid INSTRON 8506 four-column hydraulic servo testing system is used for a test. First, a test piece is placed in a center of a lower steel plate of the testing machine, and then an upper steel plate is put down and adjusted to make a surface of the test piece uniformly stressed. A preload value is set to 60 kN, and then loading is performed at a loading rate of 0.1 mm/min until the test piece is broken. Thus a complete descent section of the stress-strain curve of the concrete under compression is obtained.

As for a cubic test piece, a compressive strength value of the cubic test piece is obtained from the test mainly. A preload value is set to 60 kN, and then loading is performed in a stress control manner at a loading rate of 0.6 MPa/s until the test piece is destroyed.

### (3) Four-Point Bending Test

A bending property of the concrete are measured by means of a four-point bending test. A Toni bending and compression testing machine is used as a testing device. Working parameters of the testing machine include a maximum compression load being 3000 kN, maximum compression displacement being 60 mm, a maximum bending load being 200 kN, and maximum displacement of 100 mm by using a linear variable differential transformer (LVDT). Continuous loading is performed in a displacement control manner at a rate of 0.1 mm/min until a crack in the test piece propagates through an entire cross section. The LVDT is used to monitor vertical displacement of the test piece during the test.

The following contents are an analysis of test results of the above tests.

### I. Compressive Strength Test

### 1. Axial Compressive Strength

Stress-strain curves of all groups of typical FRC prismal test pieces under uniaxial compression are constructed. Specifically, stress-strain curves of test pieces corresponding to chopped basalt fibers with volume fractions of 0% to 0.5% are set under uniaxial compression. The curves represent stress-strain curves of three different test pieces corresponding to the chopped basalt fibers with a same volume fraction under uniaxial compression. By observing results, it is found that the stress-strain curves have a same general trend and are slightly different due to differences of test piece making conditions and test conditions. Due to addition of the fibers with different volume fractions, descent sections of the groups of the test pieces are different. For a control test piece B0 without fibers, after a peak stress is reached, the stress decreases sharply along with an increase of strain, present as an extremely steep curve of a descent section. Then, the curve of the test piece tends to be flat after the compressive strain is about 0.5%, showing certain residual strength, and a mean compressive stress is 5.93 MPa. For the basalt fiber reinforced concrete test piece, a peak value of compressive stress decreases, a descent section of the curve is steep, but compared with the control test piece B0, the curve becomes flatter, showing certain ductile failure characteristics.

Stress-strain curve envelope areas of descent sections of compressive stress-strain curves corresponding to test pieces B0.1 and B0.2 are obviously larger than those of other test pieces. When the compressive strain is 0.5%, the compressive stress is 10.61 MPa and 7.22 MPa respectively, which is higher than those of test piece B0 by 78.92% and 21.75% respectively. Ductility of the basalt fiber reinforced concrete under compressive failure conditions is enhanced.

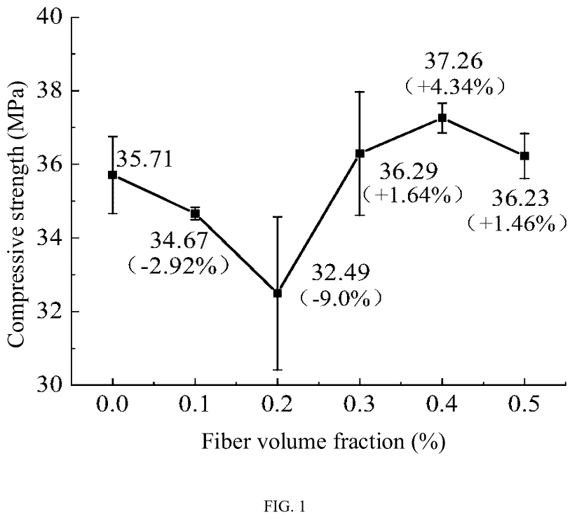

For the prismal test pieces, peak compressive strength f_{c} of the fiber reinforced concrete test pieces with different proportions in the uniaxial compression test is shown in FIG. 1. Axial compressive strength of the test pieces having basalt fibers with 0.1% to 0.5% volume fractions is 34.67 MPa, 32.49 MPa, 36.29 MPa, 37.26 MPa, and 36.23 MPa respectively. The axial compressive strength increases by −2.92%, −9.00%, 1.64%, 4.34% and 1.46% respectively. Thus f_{c} decreases first, then increases and then decreases along with an increase in a fiber fraction. The axial compressive strength of the concrete decreases when the fiber volume fraction is less than 0.2%, but the axial compressive strength of the concrete does not greatly increase when the fiber volume fraction is greater than 0.3%, even the axial compressive strength of the concrete test pieces is lower when the fiber volume fraction is 0.5% than 0.4%. Generally, it can be seen that the axial compressive strength of the concrete does not effectively increase with addition of the basalt fibers, and a too high fiber fraction should not be used to increase the axial compressive strength.

As for engineering structures, besides requirements of strength and stiffness need to be satisfied, ductility must also be considered. The ability of materials and structures to exhibit sufficient ductility in a case beyond normal service limit conditions increases seismic performance, reduces damage or saves lives. When a load reaches a peak value, a brittle failure occurs in most of ordinary concrete under tension or pressure. However, the addition of fiber can improve the tensile and compressive properties of test pieces in different degrees. Such a difference may be evaluated by toughness, which refers to the ability of a material to absorb energy during plastic deformation or fracture, and is related to a load bearing capacity and a deformation capacity. In order to accurately evaluate increase of the fibers in compression toughness of the concrete, with reference to the specification CECS13: 2009, a compression toughness index R_{e,1.0} is used to express the increase, and a calculation process is shown in Equation (1).

$${R}_{e , 1.} = \frac{{W}_{1.}}{{f}_{c} \times A \times {L}_{0} \times 1. \%} \qquad ( 1 )$$

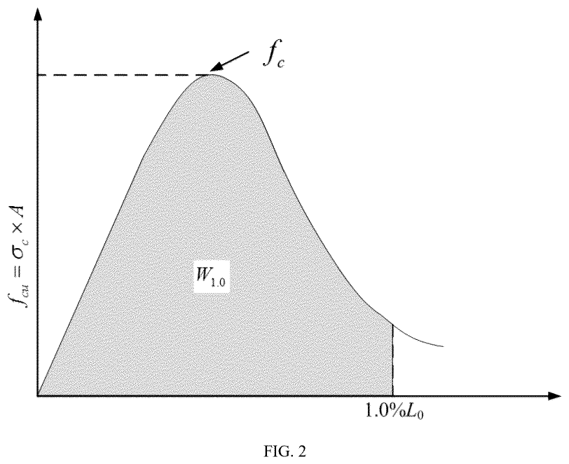

R_{e,1.0} is a compressive toughness ratio; W_{1.0} is compressive work, which refers to an envelope area of the stress-strain curve of the concrete under compression from 0 to 1.0% L0 (L0 is a compressive deformation measurement gauge length, mm), as shown in FIG. 2.

In Table 2, the compressive work and the compressive toughness ratios of the fiber reinforced concrete test pieces under a uniaxial compression load are summarized.

| | B0 | | B0.1 | | B0.2 | | B0.3 | | B0.4 | | B0.5 | |
|---|---|---|---|---|---|---|---|---|---|---|---|---|
| | Test | | Test | | Test | | Test | | Test | | Test | |
| Parameter | value | Average | value | Average | value | Average | value | Average | value | Average | value | Average |
| W_{1.0} | 27.62 | 28.39 | 36.17 | 39.42 | 33.77 | 29.71 | 34.79 | 29.29 | 36.89 | 34.19 | 26.88 | 26.64 |
| (kN · m) | 25.62 | | 42.67 | | 27.91 | | 25.43 | | 37.37 | | 27.43 | |
| | 31.93 | | / | | 27.44 | | 27.63 | | 28.32 | | 25.61 | |
| R_{e, 1.0} | 0.25 | 0.26 | 0.35 | 0.38 | 0.38 | 0.31 | 0.33 | 0.27 | 0.33 | 0.31 | 0.25 | 0.25 |
| | 0.23 | | 0.41 | | 0.28 | | 0.24 | | 0.34 | | 0.26 | |
| | 0.31 | | / | | 0.26 | | 0.24 | | 0.25 | | 0.23 | |

Table 2-4 Compressive work and compressive toughness ratios of fiber reinforced concrete test pieces under uniaxial compression load

As shown in Table 2, compared with R_{e,1.0} (0.26) of plain concrete, R_{e,1.0} of the concrete test pieces with the basalt fibers with volume fractions of 0.1% to 0.4% increases by 46.15%, 19.23%, 3.84% and 19.23% respectively. This indicates that a reasonable basalt fiber fraction can properly increase the compressive toughness of the concrete. R_{e,1.0} of the concrete test pieces with the basalt fibers with a volume fraction of 0.5% decreases to some extent. This indicates that increasing the fiber fraction blindly cannot effectively increase the compressive toughness of the concrete. Considering economic rationality, 0.1% and 0.2% of the fiber fraction produce a better improvement effect.

### 2. Cubic Compressive Strength

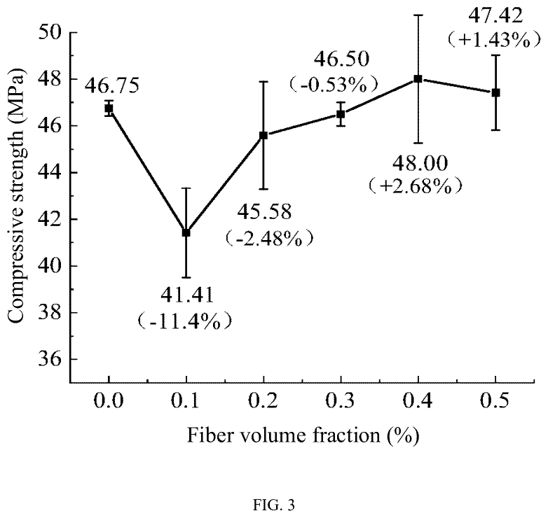

Peak compressive strength f_{cu} of all groups of typical FRC cubic test pieces under uniaxial compression is shown in FIG. 3. Similar to the figure, along with an increase in the fiber fraction, the axial compressive strength of concrete also shows a trend of decreasing first, then increasing and then decreasing. But compared with plain concrete, the f_{cu} corresponding to the test pieces with 0.1% fiber volume fraction decreases the most. The f_{cu} corresponding to the test pieces with 0.2% fiber volume fraction decreases (0.24%), and it is almost within an experimental error range. An increase amplitude of the f_{cu} of the concrete is not large along with an increase in the fiber volume fraction. Considering economy comprehensively, 0.2% or 0.3% fiber volume fraction can not only increase the compressive ductility of the concrete, but also guarantee the compressive strength of the concrete to remain unchanged.

### II. Tensile Strength Test

### 1. Axial Tensile Strength

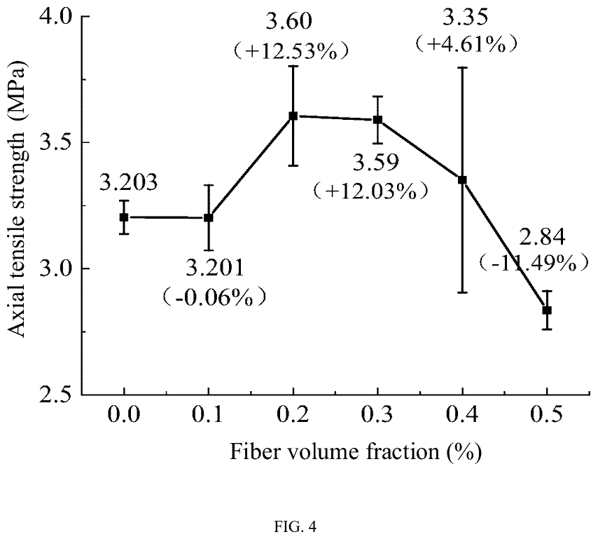

Cutting in the middle of concrete increases stress of a cutting section, such that a tensile failure section of the concrete is guaranteed to appear in the middle of the concrete. However, stress-strain curves of all groups of FRC axial tensile test pieces are not true under such a condition. Generally speaking, descent sections of the tensile stress-strain curves of the groups of test pieces are steep and incomplete. The descent sections of the tensile stress-strain curves of the basalt fiber reinforced concrete test pieces are relatively flat, but still show a brittle failure. Limited by test conditions, a post-peak stage is incomplete, but the peak tensile strength fₜ values of different fiber reinforced concrete test pieces are still obtained from a uniaxial tensile test, as shown in FIG. 4.

The axial tensile strength fₜ of the test pieces with 0% to 0.5% of fiber fraction s is 3.203 MPa, 3.201 MPa, 3.60 MPa, 3.59 MPa, 3.35 MPa, and 2.84 MPa respectively. It can be seen that compared with plain concrete, the fₜ values of the concrete test pieces with basalt fibers increases firstly (0.1% to 0.2%) and then decreases (0.3% to 0.5%) along with an increase in a fiber volume fraction. When the fiber fraction is 0.2%, the fₜ has a largest increase amplitude of 12.53%. After that, although the fₜ of the concrete test pieces with 0.3% and 0.4% fiber volume fraction still has positive increases amplitudes, increasing the fiber fraction in this case does not greatly increase the compressive strength of the concrete, and is inconducive to improvement in a tensile property. Therefore, fiber reinforced concrete with 0.2% volume fraction has an optimal axial tensile property.

### 2. Splitting Tensile Strength

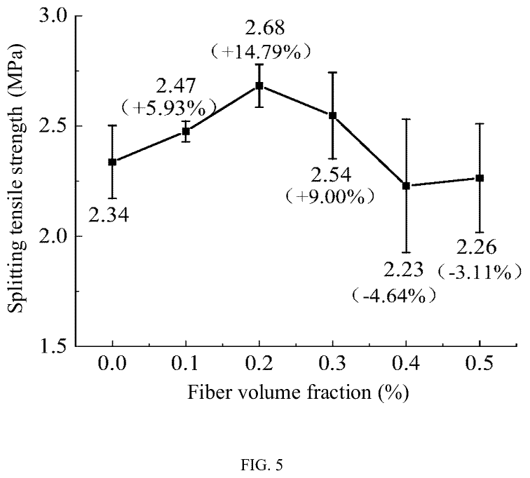

FIG. 5 shows results of a splitting tensile test.

It can be seen that splitting tensile strength (fₜₘ) values of the test pieces with 0% to 0.5% of fiber fraction s are 2.34 MPa, 2.47 MPa, 2.68 MPa, 2.54 MPa, 2.23 MPa and 2.26 MPa respectively. Accordingly, compared with plain concrete, the fₜₘ values of the concrete test pieces with basalt fibers increase firstly (0.1% to 0.2%), then decrease (0.3% to 0.4%) and then increase (0.5%) along with an increase in a fiber volume fraction. When the fiber fraction is 0.2%, the fₜₘ has a largest increase amplitude of 14.79%. This is consistent with an axial tensile strength law. Although the fₜₘ value of the concrete with 0.5% fiber volume fraction slightly increases compared with that of the concrete with 0.4% fiber volume fraction, values are basically within the error range. This is uneconomical and unreasonable. Therefore, fiber reinforced concrete with 0.2% volume fraction has an optimal splitting tensile property.

Iii. Four-Point Bending Test

Load-deflection curves of all groups of fiber reinforced concrete test pieces are constructed. The curves represent load-deflection curves of different test pieces corresponding to chopped basalt fibers with a same volume fraction. By observing results, it is found that the load-deflection curves of the test pieces have a same general trend and are slightly different due to differences of test piece making conditions and test conditions.

Based on the test results, it can be seen that a descent section of a curve of the control concrete test piece B0 is almost vertical. This indicates that concrete brittleness is significant. After the load-deflection curves of the (0.1%, 0.2%, 0.3%) basalt fiber reinforced concrete test pieces reach peak loads, the loads decrease rapidly, the test pieces fracture in the middles, showing obvious brittle nature. After the load-deflection curves of the (0.4%, 0.5%) basalt fiber reinforced concrete test pieces reach peak loads, the curves do not decrease vertically. This indicates that bending toughness of concrete with higher fraction s of basalt fibers is slightly increased, and ductility of the concrete is enhanced in this case. Generally speaking, since finer fibers cannot bridge a crack in a crack propagation process like coarser fibers, a load capacity of the test pieces with the basalt fibers still drops instantaneously after the peak loads are reached, but the peak loads greatly increase. The addition of the finer basalt fibers greatly increases the bending property of the concrete test pieces.

The peak loads of the test piece groups are extracted, and the bending strength of the concrete is calculated according to the following formula (2):

$${f}_{b} = \frac{P \times L}{b \times {h}^{2}} \qquad ( 2 )$$

In the formula, fb is a bending load; P is a peak load; Lis a span of a test piece; b is a section width of the test piece; and h is a section height of the test piece.

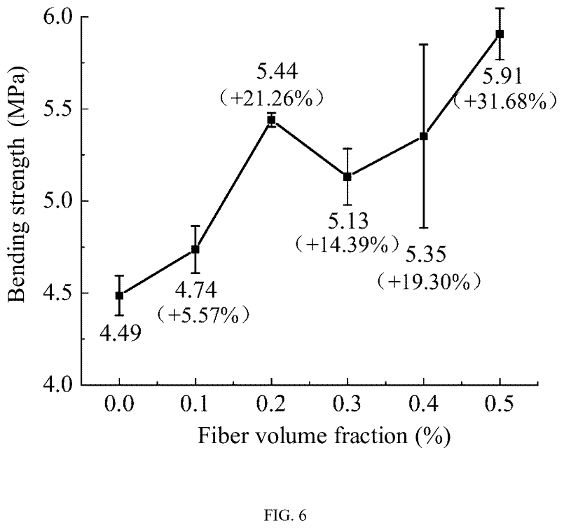

Bending strength of the fiber reinforced concrete in the test is shown in FIG. 6. The bending strength of the control test piece (B0) is 4.49 MPa. The bending strength of the test pieces with 0.1% to 0.5% of basalt fiber fraction s are 4.74 MPa, 5.44 MPa, 5.13 MPa, 5.35 MPa and 5.91 MPa respectively. The strength increases by 5.57%, 21.26%, 14.38%, 19.30% and 31.68% respectively. Although adding the basalt fibers can increase the bending strength of the concrete, the bending strength does not increase linearly along with an increase in a fiber volume fraction. The concrete with 0.2% and 0.5% fiber volume fractions has the largest bending strength. Considering economic cost comprehensively, the bending strength of the concrete with 0.2% fiber volume fraction can better increase.

A summary of test results is shown in Table 3.

TABLE 3
Summary table of test results of fiber reinforced concrete

| | Axial compressive | | Cubic compressive | | Splitting tensile | | Axial tensile | | Bending | |
|---|---|---|---|---|---|---|---|---|---|---|
| | strength (MPa) | | strength (MPa) | | strength (MPa) | | strength (MPa) | | Strength (MPa) | |
| Test | Test | | Test | | Test | | Test | | Test | |
| piece | value | Average | value | Average | value | Average | value | Average | value | Average |
| B0 | 36.44 | 35.71 | 46.36 | 46.75 | 2.57 | 2.34 | 3.14 | 3.20 | 4.38 | 4.49 |
| | 36.45 | | 46.71 | | 2.20 | | 3.27 | | 4.59 | |
| | 34.23 | | 47.17 | | 2.24 | | | | / | |
| B0.1 | 34.50 | 34.67 | 43.56 | 41.41 | 2.52 | 2.48 | 3.13 | 3.20 | 4.74 | 4.74 |
| | 34.83 | | 41.77 | | 2.49 | | 3.38 | | 4.58 | |
| | / | | 38.91 | | 2.41 | | 3.10 | | 4.89 | |
| B0.2 | 29.85 | 32.49 | 46.67 | 45.59 | 2.55 | 2.68 | 3.75 | 3.61 | 5.48 | 5.44 |
| | 32.70 | | 42.39 | | 2.78 | | 3.74 | | 5.40 | |
| | 34.93 | | 47.71 | | 2.71 | | 3.33 | | / | |
| B0.3 | 34.66 | 36.29 | 45.82 | 46.50 | 2.31 | 2.55 | 3.52 | 3.59 | 4.99 | 5.13 |
| | 35.62 | | 47.05 | | 2.55 | | 3.72 | | 5.06 | |
| | 38.60 | | 46.62 | | 2.78 | | 3.53 | | 5.34 | |
| B0.4 | 37.82 | 37.26 | 47.86 | 48.00 | 1.81 | 2.23 | 3.81 | 3.35 | 5.82 | 5.35 |
| | 36.89 | | 51.42 | | 2.34 | | 3.50 | | 4.66 | |
| | 37.06 | | 44.71 | | 2.53 | | 2.75 | | 5.58 | |
| B0.5 | 36.20 | 36.23 | 45.72 | 47.42 | 2.33 | 2.26 | 2.73 | 2.84 | 5.77 | 5.91 |
| | 35.49 | | 49.57 | | 1.93 | | 2.86 | | 6.05 | |
| | 36.99 | | 46.96 | | 2.53 | | 2.92 | | / | |

In the table, “/” indicates data missing due to test piece missing or irregular test operation.

It can be seen from Table 3 that the addition of the basalt fibers has no obvious effect on improvement of compressive strength of the concrete. The addition of the fibers increases axial tensile strength, splitting tensile strength and bending strength of the concrete as a whole, and maximum increase amplitudes are 12.53% (0.2% volume fraction), 14.79% (0.2% volume fraction) and 31.68% (0.5% volume fraction) respectively. For the splitting tensile strength, along with an increase in the fiber fraction, the splitting tensile strength of the concrete increases first and then decreases, and reaches a peak value of 14.79% when the fiber volume fraction is 0.2%. For the axial tensile strength, along with the increase in the fiber fraction, the axial tensile strength of the concrete also presents a similar law to the splitting tensile strength, and the tensile strength of the concrete with 0.2% fiber volume fraction is 3.61 MPa, which is higher than that of plain concrete by 12.53%. For the bending strength, the increase in fibers leads to the bending strength of the concrete increases first and then decreases. The bending strength reaches peak values of 21.26% and 31.68% when the fiber volume fractions are 0.2% and 0.5% respectively. Considering that the fiber volume fraction of 0.5% cannot effectively increase the tensile and compressive properties of the concrete, the fiber volume fraction of 0.2% is selected as an optimal ratio. In this case, the addition of the fibers increases the tensile strength, the bending strength and toughness of the concrete, such that crack resistance of a concrete structure can be increased.

In combination with the above test results, the example of the disclosure also provides a fitting analysis for the test results.

### 1. Compression Test

Currently, scholars at home and abroad have proposed numerous kinds of stress-strain curve equations for concrete under compression. Numerous scholars suggest that ascent sections and descent sections of an entire curve should be fitted with different equation forms, such that different function types play an advantage in different curve sections. This suggestion is favored by numerous engineers. For fiber reinforced concrete materials, a stress-strain relation equation of concrete under uniaxial compression given in Code for Design of Concrete Structures (GB 50010-2010) is mostly applied, and a concept of a damage evolution parameter of concrete under uniaxial compression is introduced, which belongs to an elastoplastic damage constitutive model, and can better describe plastic accumulation and stiffness degradation of fiber reinforced concrete. Relevant equation forms are shown in formulas (3) to (6):

$${σ}_{\text{?}} = \{ \begin{matrix}\frac{{ρ}_{\text{?}} n}{n - 1 + {x}^{n}} {E}_{\text{?}} {ε}_{\text{?}} x & ( x \leq 1 ) \\ \frac{{ρ}_{\text{?}} n}{{{α}_{\text{?}} ( x - 1 )}^{2} + x} {E}_{\text{?}} {ε}_{\text{?}} x & ( x > 1 )\end{matrix} \qquad ( 3 )$$

$${ρ}_{\text{?}} = \frac{{f}_{\text{?}}}{{E}_{\text{?}} {ε}_{\text{?}}} \qquad ( 4 )$$

$$n = \frac{{E}_{\text{?}} {ε}_{\text{?}}}{{E}_{\text{?}} {ε}_{\text{?}} - {f}_{\text{?}}} \qquad ( 5 )$$

$$x = \frac{ε}{{ε}_{\text{?}}} \qquad ( 6 )$$

$$\text{?} \text{indicates text missing or illegible when filed}$$

In the formulas, α_{c} is a shape parameter of a descent section of the stress-strain curve under compression, f_{c} is uniaxial compressive strength of the concrete, ε_{c} is the peak compressive strain corresponding to the uniaxial compressive strength f_{c}, and E_{c} is an elastic modulus of the concrete. According to formulas (3) to (6) and experimental data, corresponding fitting curves are obtained by nonlinear fitting of the stress-strain curves of the concrete under uniaxial compression.

It can be seen that the stress-strain curve of the basalt fiber reinforced concrete under compression may be described well by controlling the parameters f_{c}, ε_{c} and α_{c}. By observing the curve, it can be seen that a fitting effect of the stress-strain curve under compression is desirable. The stress-strain curve under uniaxial compression recommended by GB 50010-2010 can be used for stress-strain response of the basalt fiber reinforced concrete under uniaxial compression.

### 2. Tension Test

For ease of curve analysis, a concrete tensile constitutive equation is generally expressed in dimensionless coordinates.

$$x = \frac{ε}{{ε}_{\text{?}}} , y = \frac{σ}{{f}_{\text{?}}} \qquad ( 7 )$$

$$\text{?} \text{indicates text missing or illegible when filed}$$

An influence of fibers on a stress-strain curve of concrete under axial tension is mainly reflected in a descent section of the curve. Researches have shown that a stress-strain curve model under axial tension cannot adapt to fiber reinforced concrete in a case that a descent section is too steep. A stress-strain damage constitutive curve under axial tension proposed by Zhang Ying et al. according to GB 50010-2010 fits a stress-strain curve of steel fiber reinforced high strength concrete well. In a constitutive model, the descent section of the curve is mainly controlled by a shape parameter αₜ (the less αₜ is, the flatter the descent section is; and when αₜ approaches zero, the descent section is almost horizontal). The adjustment of the parameter greatly increases applicability of the model to fiber reinforced concrete materials. A relevant formula is as follows:

$${σ}_{\text{?}} = \{ \begin{matrix}{ρ}_{\text{?}} ( 1.2 - 0.2 {x}^{\text{?}} ) {E}_{\text{?}} {ε}_{\text{?}} x & ( ε \leq {ε}_{\text{?}} ) \\ \frac{{ρ}_{\text{?}} x}{{{α}_{\text{?}} ( x - 1 )}^{1.7} + x} {E}_{\text{?}} {ε}_{\text{?}} & ( ε > {ε}_{\text{?}} )\end{matrix} \qquad ( 8 )$$

$$x = \frac{ε}{{ε}_{\text{?}}} \qquad ( 9 )$$

$${ρ}_{\text{?}} = \frac{{f}_{\text{?}}}{{E}_{\text{?}} {ρ}_{\text{?}}} \qquad ( 10 )$$

$$\text{?} \text{indicates text missing or illegible when filed}$$

in the formula, αₜ is the shape parameter of the descent section of the stress-strain curve of concrete under uniaxial tension; fₜ is uniaxial tensile strength of the concrete; εₜ is peak tensile strain corresponding to the uniaxial tensile strength fₜ; and E_{c} is an elastic modulus of the concrete.

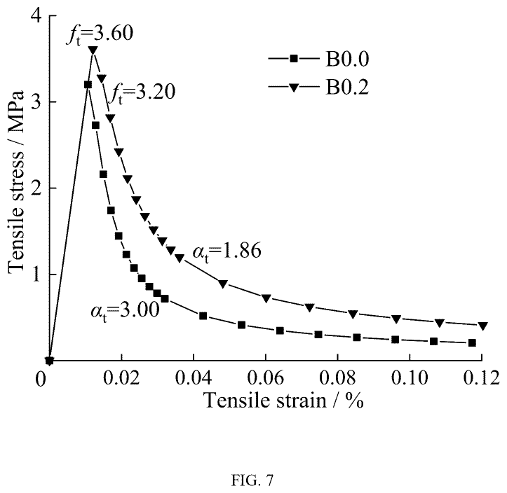

With reference to existing research results, the stress-strain curve of the fiber reinforced concrete under tensile can be described well by the parameters fₜ, εₜ and αₜ. In an ascent section of the curve, the test piece exhibits strong elastic material properties, and the stress-strain curve is almost straight, such that a fitting effect is excellent. For the descent section of the curve, the descent section of the curve becomes flatter than that of a control group without fibers due to an improvement effect of the fibers. An influence of the fiber fraction on the descent section of the stress-strain curve of the concrete test piece can be reflected by the shape parameter αₜ. According to formulas (8) to (10), and by controlling fₜ, average stress-strain curves of plain concrete and basalt fiber reinforced concrete with an optimal proportion under tensile are provided in FIG. 7.

Collection, storage, use, processing, transmission, provision and disclosure of personal information of users involved in the disclosure comply with relevant laws and regulations and do not violate public order and good custom.

It should be note that the personal information of users should be collected for legitimate and reasonable purposes and should not be shared or sold except for those legitimate uses. Moreover, such collection/sharing should be performed upon receipt of the informed consent of a user. For example, before the user uses the function, the user is informed to read a user agreement/user notification and sign the agreement/authorization including authorization of relevant user information. Moreover, it is required to take any necessary steps to safeguard and secure access to such personal information data and guarantee that others who have access to the personal information data comply with the privacy policies and procedures.

The disclosure is expected to provide embodiments in which a user selectively blocks use of or access to personal information data. That is, the disclosure is expected to provide hardware and/or software to prevent or block access to such personal information data. Once personal information data is no longer needed, risk can be minimized by limiting data collection and deleting data. Moreover, where applicable, such personal information is de-identified to protect user privacy.

In the description of the above examples, the descriptions with reference to the terms “an example”, “some examples”, “an instance”, “specific instances”, or “some instances”, etc., mean that a specific feature, structure, material, or characteristic described in connection with the example or instance falls within at least one example or instance in the disclosure. In the description, the illustrative expressions of the above terms do not indicate the same example or instance necessarily. Moreover, the specific feature, structure, material, or characteristic described can be combined in any one or more examples or instances in a suitable way. Moreover, those skilled in the art can integrate and combine different examples or instances and features in different examples or instances described in the description without contradiction.

Moreover, the terms “first” and “second” are merely for description and cannot be interpreted as indicating or implying relative importance or implicitly indicating the number of technical features indicated. Therefore, the features defined with “first” and “second” can explicitly or implicitly include at least one feature. In the description of the disclosure, “a plurality of” means at least two, such as two or three unless definitely and specifically limited otherwise.

Any process or method description in a flowchart or other manners herein may be understood to represent a module, segment, or portion of a code that includes one or more executable instructions for implementing a customized logical function or process. The scope of preferred embodiments of the disclosure includes additional implementation in which functions may be executed out of the order shown or discussed, for example, in a substantially simultaneously order or a reverse order according to the functions involved. This should be understood by those skilled in the art to which the examples of the disclosure belong.

Those of ordinary skill in the art can understand that all or some of the steps carried in the method of the above example can be implemented by instructing related hardware through a program, the program can be stored in a computer-readable storage medium, and the program includes one or a combination of the steps of the method example when executed.

In addition, all function units in each example of the disclosure may be integrated into one processing module. Each unit may also be physically present alone. Two or more units may also be integrated into one module. The integrated module described above may be implemented in the form of hardware, or in the form of a software functional module. In a case that the integrated module is implemented in the form of a software functional module, and sold or used as an independent product, the integrated module may be stored in one computer-readable storage medium.

The storage medium mentioned above may be a read-only memory, a magnetic disk, an optical disk, etc. Although the examples of the disclosure have been shown and described above, it should be understood that the above examples are illustrative and are not to be construed as limiting the disclosure. Variations, modifications, substitutions, and transformation of the above examples may be made by those of ordinary skill in the art within the scope of the disclosure.

1. Basalt fiber reinforced concrete using an excavated material as aggregate, manufactured from ingredients according to a mix proportion as follows: 100 parts of cement, 300 parts of coarse aggregate, 226.4 parts of fine aggregate, 40 parts of water, 1 part of a water reducing agent, and chopped basalt fibers, wherein gneiss is crushed to manufacture the coarse aggregate and the fine aggregate, and is sieved to obtain first coarse aggregate with a grain size of 5 mm to 10 mm, second coarse aggregate with a grain size of 10 mm to 20 mm, and the fine aggregate with a grain size of 0.37 mm to 0.52 mm; in the coarse aggregate, an ingredient mix proportion of the first coarse aggregate to the second coarse aggregate is 1:1; and a volume fraction of the chopped basalt fibers is 0% to 0.5%, and an optimal volume fraction is 0.2%.

2. The basalt fiber reinforced concrete using an excavated material as aggregate according to claim 1, wherein the gneiss used to manufacture the coarse aggregate and the fine aggregate has natural density of 2.72 g/cm³ to 2.75 g/cm³, dry density of 2.71 g/cm to 2.74 g/cm³, a saturated water absorption rate of 0.21 to 0.34, saturated compressive strength of 54 MPa to 86 MPa, a softening coefficient of 0.6 to 0.78, and a freeze-thaw loss rate of 0.01 to 0.05; after the gneiss is crushed and sieved, the obtained coarse aggregate has apparent density of 2.69 g/cm³ to 2.72 g/cm³, a water absorption rate of 0.82% to 0.89%, dry bulk density of 1.86 g/cm³ to 1.88 g/cm³, close bulk density of 2.10 g/cm³ to 2.11 g/cm³, and a particle size modulus of 7.54 to 8.14; and the fine aggregate has bulk density of 1.57 g/cm³ to 1.61 g/cm³, apparent density of 2.75 g/cm³ to 2.76 g/cm³, and a fineness modulus of 2.35 to 3.45.

3. The basalt fiber reinforced concrete using an excavated material as aggregate according to claim 1, wherein the water reducing agent is a polycarboxylate high-performance water reducing agent, and has density of 1029 kg/m³ and a water reducing rate of 28%, and a mixing amount of the water reducing agent is 1% of cement mass.

4. The basalt fiber reinforced concrete using an excavated material as aggregate according to claim 1, wherein the cement is ordinary Portland cement with a strength grade of P.O32.5.

5. The basalt fiber reinforced concrete using an excavated material as aggregate according to claim 1, wherein the chopped basalt fibers have a length of 12 mm, and are manufactured from chemical ingredients according to an ingredient proportion as follows:
45% to 60% of SiO₂; 12% to 19% of Al₂O₃; 4% to 6% of CaO; 3% to 4% of MgO; 2.5% to 4% of Na₂O+K₂O; 0.9% to 2% of TiO₂; and 7% to 15% of FeO+Fe₂O₃.

6. The basalt fiber reinforced concrete using an excavated material as aggregate according to claim 5, wherein the chopped basalt fibers have material parameters as follows:
a diameter is 0.013 mm, tensile strength is 3300 MPa to 4500 MPa, an elastic modulus is 95 GPa to 115 GPa, a capacity is 2650 kg/m³, a fracture elongation is 3.2%, a shape is flat and straight shape, a service temperature is −269° C. to 700° C., a thermal conductivity coefficient is 0.031 w/m·k to 0.038 w/m·k, a specific volume resistance is 1×10¹² ohm·M, and a sound absorption coefficient is 0.9 to 0.99.

7. A method for manufacturing basalt fiber reinforced concrete using an excavated material as aggregate, comprising:
placing 150 parts of coarse aggregate and fine aggregate into a mixer with a mixing drum having a wet inner surface, adding chopped basalt fibers with a preset volume fraction in a continuous mixing process, and continuously mixing for two first preset time intervals after addition is completed;
turning off the mixer, slowly placing 100 parts of cement into the mixing drum, and starting the mixer to mix for one first preset time interval;
slowly and evenly placing 40 parts of water and 1 part of a water reducing agent into the mixing drum, continuing to mix for two first preset time intervals, and then taking out a mixture;
placing the mixture into a mold, and vibrating the mold on a vibration table for 1 to 2 first preset time intervals, so as to guarantee that a test piece is vibrated compactly; and
performing demolding after sealing and curing with a plastic film for a second preset time interval, and placing the test piece into a standard curing room for curing.

8. The method for manufacturing basalt fiber reinforced concrete using an excavated material as aggregate according to claim 7, wherein in a case that the chopped basalt fibers are agglomerated when mixed after added, the mixer is halted, and agglomerated fibers are scattered and then continue being mixed.

9. The method for manufacturing basalt fiber reinforced concrete using an excavated material as aggregate according to claim 7, a curing temperature in the standard curing room is 20±2° C., and relative humidity is 95%.

10. The method manufacturing for basalt fiber reinforced concrete using an excavated material as aggregate according to claim 7, wherein the first preset time interval is one minute, and the second preset time interval is one day.
